(19) United States
(12) Patent Application Publication
(10) Pub. No.: US 2022/0185028 A1
(43) Pub. Date: Jun. 16, 2022

(54) WINTER TIRE WITH STUDS

(71) Applicant: The Goodyear Tire & Rubber Company, Akron, OH (US)

(72) Inventor: Frédéric Michel-Jean Pons, Thionville (FR)

(21) Appl. No.: 17/541,464

(22) Filed: Dec. 3, 2021

Related U.S. Application Data
(60) Provisional application No. 63/126,118, filed on Dec. 16, 2020.

(51) Int. Cl. B60C 11/16

(52) U.S. Cl. CPC B60C 11/1631; B60C 11/1675

(57) ABSTRACT

This invention relates to a tire having a directional tread pattern with a first shoulder region, a central region, and a second shoulder region, the tire having a plurality of studs in the first shoulder region, the second shoulder region, and the central region; wherein at least some of the plurality of the studs in the central shoulder region extends longitudinally into the tread member in a direction inclined relative to the normal of the outer surface of the tread member by an angle in the circumferential direction of the tire, and wherein at least some of the studs in the first shoulder region and the second shoulder region extend longitudinally into the tread in a direction inclined relative to the normal of the outer surface of the tread in a direction different from the studs in the central region.

This application claims benefit of U.S. Provisional Patent Application Ser. No. 63/126,118, filed on Dec. 16, 2020. The teachings of U.S. Provisional Patent Application Ser. No. 63/126,118 are incorporated herein by reference in their entirety.

### FIELD OF THE INVENTION

This invention relates to a tire and in particular to a tire that can be used as a winter tire and that comprises studs installed in its tread member.

### BACKGROUND OF THE INVENTION

Winter tires may be equipped with studs installed in the tread portion of the tire to allow the tire to better grip an icy or snow covered road surface. Such studs may be at least partially embedded into a stud installation hole provided in the tread member of the tire.

The stud may broaden a pin bore and typically is tightly embedded therein so that the stud does not fall out of the stud installation hole due to forces exerted on it during driving, such as those that occur during acceleration and braking as well at forces attributable to lateral and vertical forces received from the road surface while the tire is rotating. The stud may have a body and a stud pin with a tip end protruding out of the body.

The body may be fitted into a blind hole formed in the tread member of the tire and thereby be secured to the tread surface. The tip end is the portion of the stud pin that protrudes radially outward from the body. The body may be asymmetrically and/or irregularly shaped as it extends radially outward from the tread member.

When studded snow tires are used on concrete or asphalt road surfaces which are not covered by snow or ice, these harder, bare road surfaces may dislodge the studs. Even for tires equipped with the above-mentioned studs, there are cases where the studs often fall out (pin drop) due to the forces applied to the tire while a vehicle is driving, braking, and/or steering on a concrete or asphalt road. Therefore, good care is to be taken to avoid pin drop for these pneumatic stud tires, as well as, to keep the other performance characteristics of the studs (e.g., traction, durability, wear, etc.).

At the same time, there is a constant need for improvement of the gripping performance of the tire on ice either during braking and/or accelerating and or for improvement of the transversal grip of the tire.

### SUMMARY OF THE INVENTION

One or more of the above needs can be fulfilled by the tire according to the disclosure wherein at least a part of the studs extends longitudinally into the tread member in a direction inclined relative to the normal of the outer surface of the tread member thereby forming inclined studs. The present disclosure provides for distribution and/or orientation of the inclined studs on a tread member to allow improving the performance of the tire on ice.

According to a first aspect, the disclosure provides for a tire comprising a tread member having a directional tread pattern and which is divided in the tire width direction between a central region placed between a first shoulder region and a second shoulder region, the tire comprising a first plurality of studs installed in the first shoulder region and a second plurality of studs installed in the second shoulder region and a third plurality of studs installed in the central region; each of the studs comprising a body and a stud pin with a tip end protruding out of the body, the body being at least partially embedded in the tread member; wherein at least a part of the third plurality of the studs extends longitudinally into the tread member in a direction inclined relative to the normal of the outer surface of the tread member by a first angle α in the circumferential direction of the tire; and wherein at least a part of the first and second plurality of studs extends longitudinally into the tread member in a direction inclined relative to the normal of the outer surface of the tread member in a direction being the same or different than the third plurality of the studs; with preference, in a direction being different than the third plurality of the studs.

According to a second aspect, the disclosure provides for a tire comprising a tread member which is divided in the tire width direction between a central region placed between a first shoulder region and a second shoulder region, the tire comprising a first plurality of studs installed in the first shoulder region and a second plurality of studs installed in the second shoulder region and a third plurality of studs installed in the central region; wherein each of the studs comprises a body and a stud pin with a tip end protruding out of the body and the tip ends of the stud pins of the first shoulder region and the second shoulder region have an elongated shape, and further wherein at least a part of the first plurality of studs installed in the first shoulder region or at least a part of the second plurality of studs installed in the second shoulder region or a combination of those extends longitudinally into the tread member in a direction inclined relative to the normal of the outer surface of the tread member by an angle β in the tire width direction, and the angle β is ranging from 5° to 40°.

According to a third aspect, the present disclosure provides for a tire comprising a tread member having a directional tread pattern and which is divided in the tire width direction between a central region placed between a first shoulder region and a second shoulder region, the tire comprising a first plurality of studs installed in the first shoulder region and a second plurality of studs installed in the second shoulder region and a third plurality of studs installed in the central region; each of the studs comprising a body and a stud pin with a tip end protruding out of the body, the body being at least partially embedded in the tread member; wherein at least a part of the third plurality of the studs extends longitudinally into the tread member in a direction inclined relative to the normal of the outer surface of the tread member by a first angle α in the circumferential direction of the tire, wherein the first angle α is ranging from 5° to 40°, and wherein the tip end size of the third plurality of studs is smaller than the tip end size of the first and second plurality of studs, wherein the size of a tip end is defined by the maximum cross-section of said tip end.

The following can be used to further define the tire according to the first aspect, the second aspect and the third aspect. In the present description, the studs refer to both inclined studs (i.e. to studs that extend longitudinally into the tread member in a direction inclined relative to the normal of the outer surface of the tread member), and to studs that extend longitudinally into the tread member in a direction parallel to the normal of the outer surface of the tread member unless specified otherwise.

For example, the tire can be a pneumatic tire or a non-pneumatic tire with the preference being for a pneumatic tire. For example, the stud pins of the first plurality of studs, or the second plurality of studs or the third plurality of the studs or any combination of those are made of tungsten carbide. For example, the first plurality of studs, the second plurality of studs, and the third plurality of studs each have a body with identical construction.

In the present disclosure, it is preferred that when one or more of the first plurality of studs, the second plurality of studs, and the third plurality of studs are inclined, the one or more studs are fixedly arranged in order to form an angle relative to the orientation normal to the surface of the tire tread.

### As Regards the Different Inclination of the Inclined Studs

For example, at least a part of the third plurality of the studs extends longitudinally into the tread member in a direction inclined relative to the normal of the outer surface of the tread member by a first angle α in the circumferential direction of the tire, and at least a part of the first and second plurality of studs extends longitudinally into the tread member in a direction inclined relative to the normal of the outer surface of the tread member in a direction being different than the third plurality of the studs, and one or more of the following is true:

the inclined studs of the first plurality of studs and second plurality of studs are inclined in the circumferential direction according to a first angle α that is different from the first angle α of the inclined studs of the third plurality of studs;

the inclined studs of the first plurality of studs and second plurality of studs are inclined in the circumferential direction according to a first angle α that opens in a direction relative to the direction of rotation of the tire that is different than the inclined studs of the third plurality of studs;

the inclined studs of the first plurality of studs and second plurality of studs are inclined in the width direction of the tire and the inclined studs of the third plurality of studs are inclined in the circumferential direction of the tire.

### As Regards the Inclination of the Studs in the Circumferential Direction of the Tire

For example, at least a part of the third plurality of the studs extends longitudinally into the tread member in a direction inclined relative to the normal of the outer surface of the tread member by a first angle α in the circumferential direction of the tire. For example, at least a part of the third plurality of the studs extends longitudinally into the tread member in a direction inclined relative to the normal of the outer surface of the tread member by a first angle α in the circumferential direction of the tire, wherein the first angle α (or the angle α) in the tire circumferential direction is ranging from 5° to 40° or from 10° to 40; preferably from 15° to 35°.

For example, at least a part of the first plurality of studs or at least a part of the second plurality of studs or a combination of those extends longitudinally into the tread member in a direction inclined by the first angle α in the tire circumferential direction.

For example, at least a part of the first plurality of studs and/or at least a part of the second plurality of studs extends longitudinally into the tread member in a direction inclined by the first angle α in the tire circumferential direction, wherein the first angle α in the tire circumferential direction is ranging from 5° to 40° or from 10° to 40°; preferably from 15° to 35°.

For example, the tire shows a marking indicative of the direction of rotation of the tire; and the first angle α opens from the normal of the outer surface of the tread member in the direction of rotation of the tire. For example, the tire shows a marking indicative of the direction of rotation of the tire; and the first angle α opens from the normal of the outer surface of the tread member in a direction that is reverse to the direction of rotation of the tire.

For example, the tire shows a marking indicative of the direction of rotation of the tire; and the studs that are inclined in the circumferential direction according to a first angle α are distributed in a first group wherein the first angle α opens from the normal of the outer surface of the tread member in the direction of rotation of the tire and a second group wherein the first angle α opens from the normal of the outer surface of the tread member in a direction that is reverse to the direction of rotation of the tire.

### As Regards the Inclination of the Studs in the Width Direction of the Tire

For example, at least a part of the first plurality of studs or at least a part of the second plurality of studs or a combination of those extends longitudinally into the tread member in a direction inclined by a second angle β (or an angle β) in the tire width direction. For example, at least a part of the first plurality of studs or at least a part of the second plurality of studs or a combination of those extends longitudinally into the tread member in a direction inclined by a second angle β in the tire width direction, wherein the second angle β in the tire width direction is ranging from 5° to 40° or from 10° to 40°; preferably from 15° to 35°.

### As Regards the Inclination of the Studs in the Circumferential Direction and the Width Direction of the Tire

For example, at least a part of the first plurality of studs, or at least a part of the second plurality of studs, or a combination of those extends longitudinally into the tread member in a direction inclined by a second angle β in the tire width direction, wherein the first angle α in the tire circumferential direction is ranging from 5° to 40° or from 10° to 40° degrees; preferably from 15° to 35°. For example, at least a part of the first plurality of studs, or at least a part of the second plurality of studs, or a combination of those, extends longitudinally into the tread member in a direction inclined by a second angle β (or an angle β) in the tire width direction, wherein both the first angle α in the tire circumferential direction and the second angle β in the tire width direction are ranging from 5 to 40 degrees or from 10° to 40°; preferably from 15° to 35°.

### As Regards the Orientation of the Studs

For example, the tip ends of the studs of at least one region have an arrowhead shape or an elongated shape, and the at least one region is selected from the central region, the first shoulder region and the second shoulder region. For example, the tip ends of the studs of the central region, the first shoulder region and the second shoulder region have an arrowhead shape; and at least a part of the arrowheads of the studs of the first shoulder region and/or the second shoulder region are pointing in a direction different from the direction of the arrowheads of the studs of the central region.

For example, the bottom portion has a tear-drop shape comprising three planar sides and one semi-cylindrical side, or a shape selected from a triangular shape, a quadrangular shape, a pentagonal shape, or a hexagonal shape. For example, the third plurality of studs each has a first orientation, the first plurality of studs each has a second orientation rotated relative to the first orientation from +30° to +90° along their longitudinal direction, and the second plurality of studs each has a third orientation rotated relative to the first orientation from −30° to −90° along their longitudinal direction.

For example, the body comprises a bottom portion and the bottom portion has a tear-drop shape comprising three planar sides and one semi-cylindrical side, or a shape selected from a triangular shape, a quadrangular shape, a pentagonal shape, or a hexagonal shape. For example, the tip ends of the stud pins of the first shoulder region and the second shoulder region have an elongated shape being an arrowhead shape; and at least a part of the arrowheads of the stud pins of the first shoulder region is pointing in a direction different from at least a part of the arrowheads of the stud pins of the second shoulder region.

For example, at least one region selected from the central region, the first shoulder region and the second shoulder region shows studs having a tip end with an arrowhead shape or an elongated shape, and a body with a bottom region of a tear-drop shape comprising three planar sides and one semi-cylindrical side, or a bottom region with a shape selected from a triangular shape, a quadrangular shape, a pentagonal shape, or a hexagonal shape.

### Definitions

“Asymmetric tread” means a tread that has a tread pattern not symmetrical about the center plane or the equatorial plane of the tire.

“Symmetric tread” means a tread that has a tread pattern symmetrical about the center plane or the equatorial plane of the tire.

“Circumferential” means lines or direction extending along the perimeter of the surface of the annular tread perpendicular to the axial direction.

“Axial” means lines or directions that are parallel to the axis of rotation of the tire.

“Groove” means an elongated void area in a tread that can extend circumferentially or laterally about the tread in a straight, curved or zigzag manner. Circumferentially and laterally extending grooves sometimes have common portions.

“Tread element” or “traction element” means a rib or a block element defined by having a shape adjacent groove.

“Lateral edge” means a line tangent to the laterally outermost or innermost tread contact footprint as measured under normal load and tire inflation, the line being parallel to the equatorial center plane.

“Equatorial center plane” means the plane perpendicular to the tire axis of rotation and passing through the center of the tread.

“Directional Tread Pattern” means a tread pattern designed for a specific direction of rotation.

### BRIEF DESCRIPTION OF THE DRAWINGS

FIG. 1 is schematically representing a radial orthographic view of the tread according to an embodiment of the disclosure.

FIG. 2 is schematically representing a partial cross-sectional view of a tire according to the disclosure.

FIG. 3 is schematically representing a partial cross-sectional view in the width direction of a tire according to the disclosure.

FIG. 4 is a stud that can be used in the tire according to the disclosure. FIG. 5 is a stud that can be used in the tire according to the disclosure. FIG. 6 is a stud that can be used in the tire according to the disclosure.

### DETAILED DESCRIPTION OF THE INVENTION

The following is an explanation of a pneumatic or non-pneumatic tire assembly according to the present disclosure. Reference is made to FIG. 1 showing the tread member 1 of a tire with studs (9, 11, 13) at least partially embedded in the said tread member 1.

The tire circumferential direction explained hereafter refers to the rotation direction (both rolling directions) of a tread surface of a studded tire about a tire rotation axis. The radial direction of the tire refers to a direction radiating about a direction extending orthogonally to/from the tire rotation axis. The outer side in the radial direction of the studded tire may refer to the side away from the tire rotation axis in the radial direction of the studded tire. The tire width direction may be a direction parallel to the tire rotational axis, and the outer side in the tire width direction may refer to a direction away from a tire center line of the studded tire.

A studded tire according to the present disclosure may include a carcass ply layer, a belt layer, and bead cores, which serve as a frame for the studded tire. The studded tire may further include a tread member, sidewall members, bead filler members, rim cushion members, and an innerliner member, around the frame for the studded tire.

The carcass ply layer may be formed in a toroidal shape wound between a pair of circular ring-shaped bead cores and may include rubber-coated organic fiber carcass ply members. The carcass ply layer may be configured from multiple carcass ply members or a single carcass ply member. The belt layer may be provided on the outer side in the tire radial direction of the carcass ply layer, configured in two layers of belt members. The belt layer may be constructed of rubber-coated steel cords arranged at a predetermined angle, such as 20° to 30°, relative to the tire circumferential direction. The inclination direction of the steel cords of the two layers of the belt members may be opposite to each other.

The tread member may be disposed on an outer side in the tire radial direction of the belt layer. The sidewall members may be connected to two sides of the tread member to form two sidewalls. The tread member may be configured from two layers of rubber, an upper tread member disposed on an outer side in the tire radial direction and a lower tread member disposed on an inner side in the tire radial direction. The rim cushion members may be disposed at inner sides in the tire radial direction of the sidewall members and come into contact with a rim on which the studded tire may be fitted. A bead filler material may be disposed between a portion of the carcass ply layer before the carcass ply layer is wound around the bead cores and a portion of the carcass ply layer. The innerliner member may be disposed on an inner surface of the studded tire adjacent a tire cavity region that is filled with gas enclosed by the studded tire and the rim. The studded tire may have this tire structure or any other suitable structure, pneumatic and/or non-pneumatic.

The tread member shows a tread pattern on its external surface that can be symmetric or asymmetric. For example, the tire has an asymmetric tread pattern. In one embodiment of this invention, shown in FIG. 1, the tread member 1 shows a directional tread pattern and the tire comprises a marking indicative of the direction of rotation of the tire.

The tread member 1 shows a directional tread pattern or not, the tread member 1 of the tire according to the disclosure is divided in the tire width direction between a central region 3 placed between a first shoulder region 5 and a second shoulder region 7. It is preferred that studs are installed in each of the three regions. The tire will therefore comprise a first plurality of studs 9 installed in the first shoulder region 5 and a second plurality of studs 11 installed in the second shoulder region 7 and a third plurality of studs 13 installed in the central region 3. In an embodiment, all the studs of the tire have an identical construction but can be installed differently in the tread member.

In one embodiment of this invention, a part of the studs is installed in the tread member to extend longitudinally in a direction being the normal of the outer surface of the tread member whereas another part of the studs is installed in the tread member to extend longitudinally in a direction that is inclined by comparison to the normal of the outer surface of the tread member, the latter forming a plurality of inclined studs.

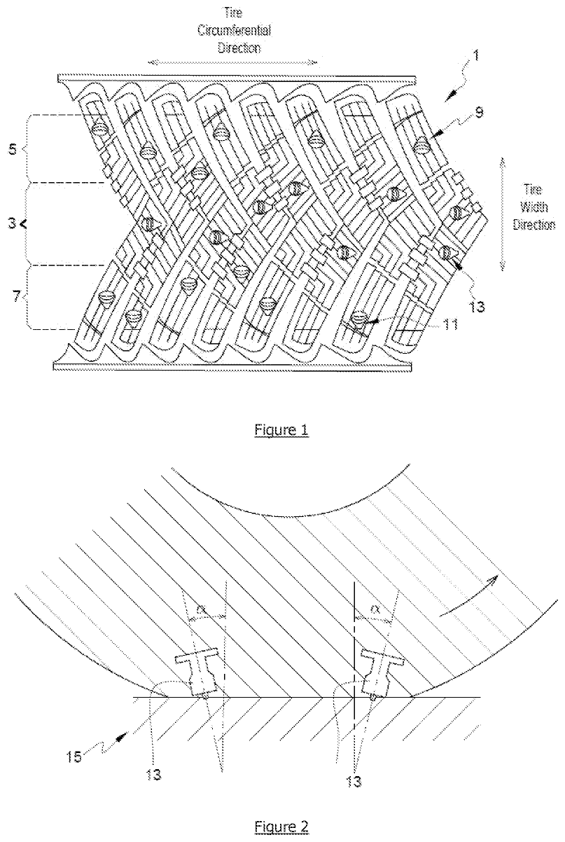

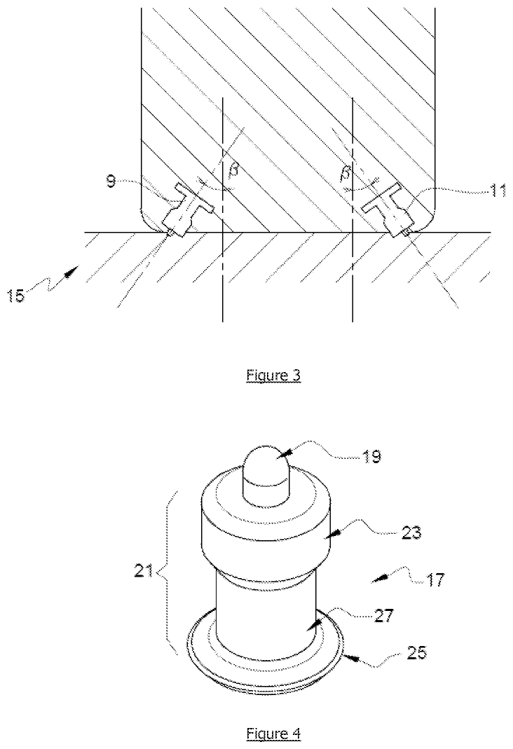

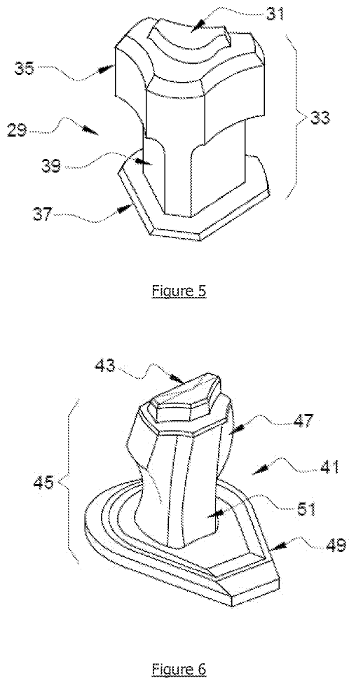

Reference is now made to FIGS. 2 and 3, where it can be seen that the inclined studs (9, 11, 13) are inclined relative to the surface of the road 15 on the part that is in contact with the surface of the road 15. To the contrary, the studs extending in a direction being the normal of the outer surface of the tread member are perpendicular to the surface of the road on the part that is in contact with the surface of the road (not shown).

The inclined studs of one or more of the first plurality of studs 9, the second plurality of studs 11 or the third plurality of studs 13 can extend longitudinally in a direction inclined by a first angle α in the tire circumferential direction; and/or to a direction inclined by a second angle β in the tire width direction.

In an embodiment, at least a part of the first plurality of studs 9 and/or at least a part of the second plurality of studs 11 extends longitudinally into the tread member in a direction inclined by the first angle α in the tire circumferential direction. The first angle α (or the angle α) may range from 5° to 40° or from 10° to 40°; preferably from 15° to 35° degrees; more preferably from 20° to 30°.

In an embodiment, at least a part of the third plurality of the studs 13 extends longitudinally into the tread member in a direction inclined relative to the normal of the outer surface of the tread member by a first angle α in the circumferential direction of the tire. The first angle α may range from 5° to 40° or from 10° to 40; preferably from 15° to 35°; more preferably from 20° to 30°.

The inclination of at least a part of the studs (9, 11, 13) in the circumferential direction of the tire improves the grip properties of the tire. For example, the tire shows a marking indicative of the direction of rotation of the tire; and the first angle α opens from the normal of the outer surface of the tread member in the direction of rotation of the tire. This may allow for increased grip during acceleration. For example, the tire shows a marking indicative of the direction of rotation of the tire; and the first angle α opens from the normal of the outer surface of the tread member in a direction that is reverse to the direction of rotation of the tire. This may improve the braking performances of the tire.

As illustrated in FIG. 2, a mix can be made so that the tire shows a marking indicative of the direction of rotation of the tire (indicated by an arrow), and the studs (9, 11, 13) that are inclined in the circumferential direction according to a first angle α are distributed in a first group wherein the first angle α opens from the normal of the outer surface of the tread member in the direction of rotation of the tire and a second group wherein the first angle α opens from the normal of the outer surface of the tread member in a direction that is reverse to the direction of rotation of the tire. For example, each of the first plurality of studs 9, the second plurality of studs 11 and the third plurality of the studs 13 can comprise studs that are inclined in the circumferential direction of both the first and the second group. For example, the first plurality of studs 9 and the second plurality of studs 11 comprise studs that are inclined in the circumferential direction and belong to the first group and the third plurality of studs 13 comprises studs that are inclined in the circumferential direction and belong to the second group. For example, the first plurality of studs 9 and the second plurality of studs 11 comprises studs that are inclined in the circumferential direction and belong to the second group and the third plurality of studs 13 comprises studs that are inclined in the circumferential direction and belong to the first group.

In an embodiment, at least 30% of the first plurality of studs 9 and/or of the second plurality of studs 11 are inclined in the tire circumferential direction; for example, at least 50%, for example at least 80%. For example, all the studs of the first plurality of studs 9 and/or all the studs of the second plurality of studs 11 are inclined in the tire circumferential direction.

In an embodiment, at least 30% of the third plurality of studs 13 are inclined in the tire circumferential direction; for example, at least 50%, for example at least 80%. For example, all the studs of the third plurality of studs 13 are inclined in the tire circumferential direction. For example, as illustrated in FIG. 3, at least a part of the first plurality of studs 9 and/or at least a part of the second plurality of studs 11 extends longitudinally in a direction inclined by a second angle β in the tire width direction. The second angle β (or the angle β) may range from 5° to 40° or from 10° to 40° ; preferably from 15° to 35°; more preferably from 20° to 30°. In other words, the second angle β is an acute angle that is preferably opened to the outer side in the tire width direction. This allows for improving the transversal grip of the tire.

Indeed, the studs (9, 11, 13) inclined in the tire width direction may be inclined in direction of the outer side in the tire width direction. In other words, wherein each of the studs (9, 11, 13) include a body and a stud pin with a tip end protruding out of the body, wherein the body includes a bottom portion located at the opposite end of the tip end, the bottom portion is closer to the tire center line of the studded tire than the tip end. As a result, the inclination direction of the studs (9, 11) of the two shoulder regions may be opposite to each other.

In an embodiment, at least 30% of the first plurality of studs 9 and/or of the second plurality of studs 11 are inclined in the tire width direction; for example, at least 50%, for example at least 80%. For example, all the studs of the first plurality of studs 9 and/or all the studs of the second plurality of studs 11 are inclined in the tire width direction. In an embodiment, at least a part of the first plurality of studs 9 and/or at least a part of the second plurality of studs 11 extends longitudinally in a direction inclined by a first angle α in the tire circumferential direction. The first angle α may range from 5° to 40° or from 10° to 40°;

preferably from 15° to 35°; and more preferably from 20° to 30°.

The first angle α used for the inclination of the first plurality of studs 9 and/or of the second plurality of studs 11 may be the same or different from the first angle α used for the inclination of the third plurality of studs 13. While it is preferred that the third plurality of the studs 13 extend longitudinally into the tread member in a direction inclined relative to the normal of the outer surface of the tread member by a first angle α in the circumferential direction of the tire, the first plurality of studs 9 and second plurality of studs 11 can be inclined either in the circumferential direction and/or in the width direction. For example, inclined studs of the first plurality of studs 9 and second plurality 11 of studs are inclined in the circumferential direction whereas a second part of the inclined studs is inclined in the width direction. For example, the inclined studs of the first plurality of inclined studs and second plurality of inclined studs are inclined in both the circumferential direction and the width direction.

In an embodiment, at least a part of the third plurality of the studs 13 extends longitudinally into the tread member in a direction inclined relative to the normal of the outer surface of the tread member by a first angle α in the circumferential direction of the tire; and at least a part of the first plurality of studs 9 and second plurality of studs 11 extends longitudinally into the tread member in a direction inclined relative to the normal of the outer surface of the tread member in a direction being the same or different than the third plurality of the studs 13; with preference, in a direction being different than the third plurality of the studs 13.

In an embodiment, at least a part of the third plurality of the studs 13 extends longitudinally into the tread member in a direction inclined relative to the normal of the outer surface of the tread member by a first angle α in the circumferential direction of the tire, and at least a part of the first plurality of studs 9 and second plurality of studs 11 extends longitudinally into the tread member in a direction inclined relative to the normal of the outer surface of the tread member in a direction being different than the third plurality of the studs 13; wherein:

the inclined studs of the first plurality of studs 9 and second plurality of studs 11 are inclined in the circumferential direction according to a first angle α that is different from the first angle α of the inclined studs of the third plurality of studs 13; and/or

the inclined studs of the first plurality of studs 9 and second plurality of studs 11 are inclined in the circumferential direction according to a first angle α that opens in a direction relative to the direction of rotation of the tire that is different than the inclined studs of the third plurality of studs 13; and/or

the inclined studs of the first plurality of studs 9 and second plurality of studs 11 are inclined in the width direction of the tire and the inclined studs of the third plurality of studs 13 are inclined in the circumferential direction of the tire.

The fact that inclined studs of the first plurality of studs 9 and second plurality of studs 11 are inclined in the circumferential direction according to a first angle α that is different from the first angle α of the inclined studs of the third plurality of studs 13 means that the inclined studs of the first plurality of studs 9 and second plurality of studs 11 are inclined in the circumferential direction according to a first angle α that is greater than the first angle α of the inclined studs of the third plurality of studs 13, or that the inclined studs of the first plurality of studs 9 and second plurality of studs 11 are inclined in the circumferential direction according to a first angle α that is smaller than the first angle α of the inclined studs of the third plurality of studs 13.

The fact that inclined studs of the first plurality of studs 9 and second plurality of studs 11 are inclined in the circumferential direction according to a first angle α that opens in a direction relative to the direction of rotation of the tire that is different than the inclined studs of the third plurality of studs 13 means that the inclined studs of the first plurality of studs 9 and second plurality of studs 11 are inclined in the circumferential direction according to a first angle α that opens from the normal of the outer surface of the tread member in the direction of rotation of the tire whereas the inclined studs of the third plurality of studs 13 are inclined in the circumferential direction according to a first angle α that opens in a direction that is reverse to the direction of rotation of the tire; or that the inclined studs of the first plurality of studs 9 and second plurality of studs 11 are inclined in the circumferential direction according to a first angle α that opens from the normal of the outer surface of the tread member in the reverse direction of rotation of the tire whereas the inclined studs of the third plurality of studs 13 are inclined in the circumferential direction according to a first angle α that opens in the direction of rotation of the tire.

A further improvement may be obtained by the use of studs (9, 11, 13) with oriented and/or elongated tip ends wherein the studs (9, 11, 13) can have a different orientation in a single tread member. Indeed, the studs (9, 11, 13) can be of any construction, but are preferably with an elongated tip end and/or with a bottom portion that prevents the rotation of the body within the tread member so that the tip ends can be oriented. For example, the studs (9, 11, 13) include a body and a stud pin with a tip end protruding out of the body, for partially inserting into corresponding recesses in the tread member. The body is at least partially embedded inside a stud installation hole in the tread member of the tire in which it is installed. The stud is secured to the tire by side surfaces of the stud installation hole pressing and clamping onto part of the body. The body may include a stump portion, a bottom portion and a shank portion interconnecting the bottom portion and the stump portion. For example, the shank portion has a thinner cross-section compared to the bottom portion and/or to the stump portion. The bottom portion is located at the opposite end of the stump portion and the tip end. The body is formed from the bottom portion, the shank portion, and the stump portion in ascending order. The longitudinal direction of the stud extends longitudinally from the bottom portion to the tip end.

When the stud is installed in the tread member, the tip end is the portion of the stud pin that protrudes from the tread surface, contacts the road surface, and claws into ice and/or snow. The stud pin and the body may be constructed of the same metallic material or from different metallic materials. For example, the stud pin and the body may be made from aluminum or steel. The stud pin may be made from tungsten carbide and the body may be made from aluminum. If the stud pin and the body are made from different metallic materials, the stud pin may be fixed to the body by pushing and interference fitting a projection of the stud pin into a hole of the stump portion of the body.

FIGS. 4 to 6 show an external perspective of studs that can be used in the context of the present disclosure for any of the first plurality of studs 9, the second plurality of studs 11 and/or the third plurality of studs 13. For example, the studs can be axially symmetric along an axis extending along the length of the stud. Examples of symmetrical studs are described in United States Patent Application Publication No. 2011/0088822 (which has been issued as U.S. Pat. No. 8,215,353 B2) and United States Patent Application Publication No. 2012/0227880. The teachings of United States Patent Application Publication No. 2011/0088822, U.S. Pat. No. 8,215,353 B2, and United States Patent Application Publication No. 2012/0227880 are incorporated herein by reference. FIG. 4 illustrates such a symmetrical stud 17 that includes a body 21 and a stud pin with a tip end 19 protruding out of the body 21 for partially inserting into corresponding recesses in the tread member. The body 21 includes a stump portion 23, a bottom portion 25, and a shank portion 27 interconnecting the bottom portion and the stump portion. In an embodiment not illustrated, the tip end has a hexagonal cross-section at least in some section. For example, the tip end is flat. For example, the tip end 19 is rounded or pointed. For example, the studs can be axially asymmetric along an axis extending along the length of the stud. An example of an asymmetrical stud is described in United States Patent Application Publication No. 2013/0000807 A1. The teachings of United States Patent Application Publication No. 2013/0000807 A1 are incorporated herein by reference.

FIG. 5 illustrates such an asymmetrical stud 29 that includes a body 33 and a stud pin with a tip end 31 protruding out of the body 33. The body 33 may include a stump portion 35, a bottom portion 37, and a shank portion 39 interconnecting the bottom portion and the stump portion. For example, the location of the center of gravity of the stump portion 35 or of the tip end 31 of the stud 29 is laterally offset from the center of gravity of the bottom portion 37; or the location of the center of gravity of the tip end 31 is laterally offset from the center of gravity of the stump portion 35, or the location of the center of gravity of the shank portion 39 is laterally offset from the center of gravity of the bottom portion 37.

For example, the studs can have a bottom portion having a tear-drop shape as disclosed in United States Patent Application Publication No. 2020/0122520 or United States Patent Application Publication No. 2020/0189325 (now issued as U.S. Pat. No. 11,084,331 B2). The teachings of United States Patent Application Publication No. 2020/0122520, United States Patent Application Publication No. 2020/0189325, and U.S. Pat. No. 11,084,331 B2 are incorporated by reference herein. FIG. 6 shows such a stud 41 that includes a body 45 and a stud pin with a tip end 43 protruding out of the body 45 for partially inserting into corresponding recesses in the tread member. The body 45 may include a stump portion 47, a bottom portion 49, and a shank portion 51 interconnecting the bottom portion and the stump portion. The tip end 43 may have a hexagonal-like shape extending outward from an outermost surface of the stump portion 47 of the body 45. The cross-section of the bottom portion 49 may alternatively be a substantially triangular, quadrangular, pentagonal, or hexagonal shape.

It is also possible that the bottom portion of the body has a “saucer” configuration such that an inclined surface extends radially inward from vertical sides of the bottom portion away from the tip end such that the inclined surface takes on the tear-drop shape or substantially triangular, quadrangular, pentagonal, or hexagonal shape of the bottom portion. Generally, the bottom portion 49 may be inserted into a corresponding similarly shaped stud installation hole in the tread member of the tire thereby securing the orientation of the stud 41 and preventing rotation of the stud during use. Alternatively, the stud installation hole may be circular or other suitable shape allowing the bottom portion 49 to be secured against rotation.

Each of the studs comprising a body and a stud pin with a tip end protruding out of the body. The tip ends of the studs of at least one region may have an arrowhead shape or an elongated shape, the at least one region being selected from the central region 3, the first shoulder region 5 and the second shoulder region 7. The tip ends of the studs of the central region 3 have therefor a given orientation that can be the same or different from the tip ends of the studs of the first shoulder region 5 and/or the second shoulder region 7. The orientation of the tip ends of the first shoulder region 5 can be the same or different from the orientation of the tip ends of the second shoulder region 7. For example, as shown in FIG. 1, wherein the third plurality of studs 13 each having a first orientation, the first plurality of studs 9 each having a second orientation rotated relative to the first orientation from +30° to +90° along their longitudinal direction, preferably from +45° to +90°; and the second plurality of studs 11 each having a third orientation rotated relative to the first orientation from −30° to −90° along their longitudinal direction, and preferably from −45° to −90°.

In an embodiment, the tip ends of the studs of the central region 3, the first shoulder region 5 and the second shoulder region 7 have an arrowhead shape, and all the arrowheads are pointing to the same direction. In an embodiment, the tip ends of the studs of the central region 3, the first shoulder region 5 and the second shoulder region 7 have an arrowhead shape; and at least a part of the arrowheads of the studs of the first shoulder region 5 and/or the second shoulder region 7 are pointing in a direction different from the direction of the arrowheads of the studs of the central region 3. For example, the first plurality of studs 9, the second plurality of studs 11, and the third plurality of studs 13 each have a body with identical construction.

In an embodiment (not shown), the third plurality of studs installed in the central region has a construction that is different from the studs installed in the first shoulder region and the second shoulder region. For example, the first plurality of studs and the second plurality of studs are axially asymmetric along their longitudinal direction whereas the third plurality of studs are axially symmetric along their longitudinal direction, or vice -versa.

In an embodiment (not shown), the tip end size of the third plurality of studs is smaller than the tip end size of the first and second plurality of studs, wherein the size of a tip end is defined by the maximum cross-section of said tip end. Having tip ends of the studs in the shoulders portions that are larger than the tip ends of the studs in the central region allows compensating for lower contact pressure. Since the effectiveness of the studs may depend on ice hardness and the capability of the tip end of the stud pin to penetrate the ice, larger tip ends may perform better than smaller tip ends in “warmer”, relatively soft ice, such as −2° C. to −5° C. Conversely, smaller tip ends may perform better than larger tip ends in “colder”, relatively hard ice, such as −20° C. to −30° C. Dual stud pins types/sizes of studs and tip ends in a single tread member may thereby perform well in both of the soft ice and hard ice circumstances described above.

The disclosure has been described with reference to preferred embodiments. Potential modifications and alterations will occur to others upon a reading and understanding of this description. It is to be understood that all such modifications and alterations are included in the scope of the disclosure as set forth in the appended claims, or the equivalents thereof. Variations in the present invention are possible in light of the provided description. While certain representative embodiments, examples and details have been shown for the purpose of illustrating the subject invention, it will be apparent to those skilled in this art that various changes and modifications can be made therein without departing from the scope of the invention. It is, therefore, to be understood that changes may be made in the particular example embodiments described which will be within scope of the invention as defined by the appended claims.

What is claimed is:

1. A tire comprising a tread member having a directional tread pattern and which is divided in the tire width direction between a central region placed between a first shoulder region and a second shoulder region, the tire comprising a first plurality of studs installed in the first shoulder region and a second plurality of studs installed in the second shoulder region and a third plurality of studs installed in the central region; each of the studs comprising a body and a stud pin with a tip end protruding out of the body, the body being at least partially embedded in the tread member; wherein at least a part of the third plurality of the studs extends longitudinally into the tread member in a direction inclined relative to the normal of the outer surface of the tread member by a first angle α in the circumferential direction of the tire; and wherein at least a part of the first and second plurality of studs extends longitudinally into the tread member in a direction inclined relative to the normal of the outer surface of the tread member in a direction being different than the third plurality of the studs.

2. The tire of claim 1 wherein one or more of the following is true:
the inclined studs of the first plurality of studs and second plurality of studs are inclined in the circumferential direction according to a first angle α that is different from the first angle α of the inclined studs of the third plurality of studs;
the inclined studs of the first plurality of studs and second plurality of studs are inclined in the circumferential direction according to a first angle α that opens in a direction relative to the direction of rotation of the tire that is different than the inclined studs of the third plurality of studs; and
the inclined studs of the first plurality of studs and second plurality of studs are inclined in the width direction of the tire and the inclined studs of the third plurality of studs are inclined in the circumferential direction of the tire.

3. The tire according to claim 1 wherein at least a part of the first plurality of studs, or at least a part of the second plurality of studs, or a combination of those, extends longitudinally into the tread member in a direction inclined by a second angle β in the tire width direction.

4. The tire according to claim 3 wherein the first angle α in the tire circumferential direction or the second angle β in the tire width direction or both the first angle α in the tire circumferential direction and the second angle β in the tire width direction are within the range of 10° to 40°.

5. The tire according to claim 1 wherein at least a part of the first plurality of studs, or at least a part of the second plurality of studs, or a combination of those, extends longitudinally into the tread member in a direction inclined by the first angle α in the tire circumferential direction.

6. The tire according to claim 1 wherein the tire shows a marking indicative of the direction of rotation of the tire; and wherein the first angle α opens from the normal of the outer surface of the tread member in the direction of rotation of the tire.

7. The tire according to claim 1 wherein the tire shows a marking indicative of the direction of rotation of the tire; and wherein the first angle α opens from the normal of the outer surface of the tread member in a direction that is reverse to the direction of rotation of the tire.

8. The tire of claim 1 wherein the tire shows a marking indicative of the direction of rotation of the tire; and wherein the studs that are inclined in the circumferential direction according to a first angle α are distributed in a first group wherein the first angle α opens from the normal of the outer surface of the tread member in the direction of rotation of the tire and a second group wherein the first angle α opens from the normal of the outer surface of the tread member in a direction that is reverse to the direction of rotation of the tire.

9. The tire according to claim 1 wherein the tip ends of the studs of at least one region have an arrowhead shape or an elongated shape, the at least one region being selected from the central region, the first shoulder region and the second shoulder region.

10. The tire according to claim 1 wherein the tip ends of the studs of the central region, the first shoulder region and the second shoulder region have an arrowhead shape;
and further wherein at least a part of the arrowheads of the studs of the first shoulder region or of the second shoulder region or of both the first and the second shoulder region are pointing in a direction different from the direction of the arrowheads of the studs of the central region.

11. The tire according to claim 1 wherein the bottom portion has a tear-drop shape comprising three planar sides and one semi-cylindrical side, or a shape selected from a triangular shape, a quadrangular shape, a pentagonal shape, or a hexagonal shape.

12. A tire comprising a tread member which is divided in the tire width direction between a central region placed between a first shoulder region and a second shoulder region, the tire comprising a first plurality of studs installed in the first shoulder region and a second plurality of studs installed in the second shoulder region and a third plurality of studs installed in the central region; wherein each of the studs comprises a body and a stud pin with a tip end protruding out of the body and the tip ends of the stud pins of the first shoulder region and the second shoulder region have an elongated shape, and further wherein at least a part of the first plurality of studs installed in the first shoulder region or at least a part of the second plurality of studs installed in the second shoulder region or a combination of those extends longitudinally into the tread member in a direction inclined relative to the normal of the outer surface of the tread member by an angle β in the tire width direction, wherein the angle β is within the range of 5° to 40°.

13. The tire according to claim 12 wherein the third plurality of studs each having a first orientation, the first plurality of studs each having a second orientation rotated relative to the first orientation from +30° to +90° along their longitudinal direction; and the second plurality of studs each having a third orientation rotated relative to the first orientation from −30° to −90° along their longitudinal direction.

14. The tire according to claim 12 wherein the first plurality of studs, the second plurality of studs, and the third plurality of studs each have a body with identical construction.

15. The tire according to claim 12 wherein the body comprises a bottom portion and the bottom portion has a tear-drop shape comprising three planar sides and one semi-cylindrical side, or a shape selected from a triangular shape, a quadrangular shape, a pentagonal shape, or a hexagonal shape.

16. The tire according to claim 12 wherein the elongated shape is an arrowhead shape, and further wherein at least a part of the arrowheads of the stud pins of the first shoulder region is pointing in a direction different from at least a part of the arrowheads of the stud pins of the second shoulder region.

17. A tire comprising a tread member having a directional tread pattern and which is divided in the tire width direction between a central region placed between a first shoulder region and a second shoulder region, the tire comprising a first plurality of studs installed in the first shoulder region and a second plurality of studs installed in the second shoulder region and a third plurality of studs installed in the central region; each of the studs comprising a body and a stud pin with a tip end protruding out of the body, the body being at least partially embedded in the tread member wherein at least a part of the third plurality of the studs extends longitudinally into the tread member in a direction inclined relative to the normal of the outer surface of the tread member by a first angle α in the circumferential direction of the tire, wherein the first angle α is within the range of 5° to 40°, and wherein the tip end size of the third plurality of studs is smaller than the tip end size of the first and second plurality of studs, wherein the size of a tip end is defined by the maximum cross-section of said tip end.

18. The tire according to claim 17, wherein at least a part of the first plurality of studs or at least a part of the second plurality of studs or a combination of those extends longitudinally into the tread member in a direction inclined by a second angle β in the tire width direction, wherein the second angle β is within the range of 10° to 40°.

19. The tire according to claim 17 wherein the stud pins of the first plurality of studs, or the second plurality of studs or the third plurality of the studs, or any combination of those are made of tungsten carbide.

20. The tire according to claim 17 wherein at least one region selected from the central region, the first shoulder region and the second shoulder region shows studs having a tip end with an arrowhead shape or an elongated shape and a body with a bottom region of a tear-drop shape comprising three planar sides and one semi-cylindrical side, or a bottom region with a shape selected from a triangular shape, a quadrangular shape, a pentagonal shape, or a hexagonal shape.
